(19) United States
(12) Patent Application Publication
(10) Pub. No.: US 2025/0218046 A1
(43) Pub. Date: Jul. 3, 2025

(54) SYSTEM AND METHOD FOR ENCODING/DECODING TWO DIMENSIONAL DATA FOR THREE DIMENSIONAL RENDERING AND APPARATUS FOR THE SAME

(71) Applicant: Electronics and Telecommunications Research Institute, Daejeon (KR)

(72) Inventors: Seong Yong LIM, Daejeon (KR); Da Yun NAM, Daejeon (KR)

(73) Assignee: Electronics and Telecommunications Research Institute, Daejeon (KR)

(21) Appl. No.: 18/790,268

(22) Filed: Jul. 31, 2024

(30) Foreign Application Priority Data
Dec. 27, 2023 (KR) 10-2023-0192511
May 23, 2024 (KR) 10-2024-0067189

(51) Int. Cl. G06T 9/00; G06T 17/00

(52) U.S. Cl. CPC G06T 9/00; G06T 17/00

(57) ABSTRACT

The present invention relates to a system and a method for encoding/decoding 2D data for 3D rendering, and an apparatus therefor. A method for encoding 2D video data for 3D rendering according to one aspect of the present disclosure may include: generating one or more 2D patch data from 2D data; generating patch area separation information for distinguishing the 2D patch data in the 2D data; generating 3D spatial information for the 2D data and/or the 2D patch data; generating a video stream including the 2D data and/or the 2D patch data and metadata for the video stream, wherein the metadata includes the patch area separation information and the 3D spatial information; and encoding the video stream and the metadata.

### CROSS-REFERENCE TO RELATED APPLICATIONS

This application claims the benefit of earlier filing date and right of priority to Korean Application No. 10-2023-0192511, filed on Dec. 27, 2023, No. 10-2024-0067189, filed on May 23, 2024, the contents of which are all hereby incorporated by reference herein in their entirety.

### TECHNICAL FIELD

The present disclosure relates to a method for encoding/decoding two-dimensional data, and more specifically, to a system and a method for encoding/decoding two-dimensional data for three-dimensional rendering, and an apparatus therefor.

### BACKGROUND

Existing 2D (2-dimensional) image/video compression and transmission standards do not include 3D (3-dimensional) spatial information corresponding to 2D images/videos. Static or dynamic 2D data can generally be encoded with image or video compression codecs such as AVC (Advanced Video Coding), HEVC (High Efficiency Video Coding), and VVC (Versatile Video Coding). In the case of VVC, a next-generation video codec, high-resolution immersive video (VR: virtual reality) is considered as one of the encoding targets. In addition, various immersive video standards utilizing existing video codecs are being revised and established. Representative examples include the MIV (MPEG Immersive Video) standard being standardized by ISO/IEC JTC 1/SC 29/WG4 and the MIV standard of WG4, which is a video compression standard for encoding, decoding, and rendering immersive video to provide viewers with a complete 6DoF (Degree of Freedom) experience. MIV provides a method to encode multi-view images into bitstreams in combination with general 2D video codecs (HEVC, VVC, etc.). The MIV encoder performs a preprocessing function to generate a small number of atlas images from multiple view images so that they can be encoded with an immersive general video encoder. MIV published DIS in January 2021, published MIV FDIS in July, and was finally officially accepted by SC29 in early October, and was established as a standard under the name of “ISO/IEC 23090-12: 2021 (E), Information technology-Coded representation of immersive media—Part 12: MPEG Immersive video.” Recently, a demo result of implementing a real-time immersive video encoding and rendering system using the MIV standard is shown. Here, the MIV Extended Restricted Geometry profile is for encoding immersive video in the form of MPI (Multiple Plane Image) format. MPI is a method of expressing a layered depth image by layering 3D space in the depth direction and reprojecting the texture on the layered planes at a certain interval based on the central camera. This layered texture and transparency information is packed into an atlas of MIV and compressed and transmitted so that it can be rendered on the terminal with relatively simple operations. MPI is the MIV profile that can most easily implement a renderer on the terminal. In a recent MPEG conference, an extension of the VVC standard to support MPI functions is being additionally discussed. Recently, video standards for immersive media have been developed, but most of them are standard technologies for videos specially produced for 6DoF (Six degrees of freedom) experiences such as 360VR, multi-view video, and multi-view video with depth image. Not only professional immersive videos, but also general 2D images/videos can be used as immersive media by placing and playing them in 3D space.

However, most existing general-purpose video codecs and immersive video standards do not include 3D spatial information for videos or certain areas within videos. In other words, there is a limitation in using existing 2D data standards to encode and transmit not only 2D data but also 3D spatial information associated with 2D data.

In addition, existing 3D media processing tools have limitations in the ability to input 2D data and perform real-time 3D rendering. Existing 3D media tools generally support real-time/non-real-time rendering by inputting 3D raw data files (OBJ, PLY, etc.) or 3D scene description files (e.g., glTF). However, most 3D media tools do not support the function of directly inputting 2D images/videos and arranging them in 3D space without a separate processing process. In order for 2D data to be played in a 3D media processing tool, a separate processing process may be required to convert the 2D data into a 3D data format and expand the dimension. That is, most existing 3D media players do not support the function of playing 2D data including 3D spatial information, and a separate data reprocessing process may be required to implement the function.

Therefore, there is a limitation in utilizing existing standards and existing 3D media tools to directly input 2D data, place 2D data in 3D space (without a separate data reprocessing process), and render and visualize the reconstructed 3D scene.

### SUMMARY

A technical object of the present disclosure is to provide a system and a method for encoding/decoding 2D data for 3D rendering, and an apparatus device therefor.

In addition, an additional technical object of the present disclosure is to provide a system and a method for receiving static/dynamic 2D data, arranging the 2D data in a 3D space, and supporting a 3D scene rendering function by utilizing an existing compression transmission standard and a media processing tool, and an apparatus therefor.

The technical objects to be achieved by the present disclosure are not limited to the above-described technical objects, and other technical objects which are not described herein will be clearly understood by those skilled in the pertinent art from the following description.

A method for encoding two-dimensional (2D) video data for three-dimensional (3D) rendering according to one aspect of the present disclosure may include: generating one or more 2D patch data from 2D data; generating patch area separation information for distinguishing the 2D patch data in the 2D data; generating 3D spatial information for the 2D data and/or the 2D patch data; generating a video stream including the 2D data and/or the 2D patch data and metadata for the video stream, wherein the metadata includes the patch area separation information and the 3D spatial information; and encoding the video stream and the metadata.

An apparatus for encoding two-dimensional (2D) video data for three-dimensional (3D) rendering according to an additional aspect of the present disclosure may include: a 2D patch data generation unit for generating one or more 2D patch data from 2D data; a patch area separation information generation unit for generating patch area separation information for distinguishing the 2D patch data in the 2D data; a 3D spatial information generation unit for generating 3D spatial information for the 2D data and/or the 2D patch data; a video stream and metadata generation unit for generating a video stream including the 2D data and/or the 2D patch data and metadata for the video stream; and encoding the video stream and the metadata. The metadata may include the patch area separation information and the 3D spatial information.

At least one non-transitory computer-readable medium storing at least one instruction according to an additional aspect of the present invention, wherein the at least one instruction executable by at least one processor may control an apparatus for encoding two-dimensional (2D) video data for three-dimensional (3D) rendering to: generate one or more 2D patch data from 2D data; generate patch area separation information for distinguishing the 2D patch data in the 2D data; generate 3D spatial information for the 2D data and/or the 2D patch data; generate a video stream including the 2D data and/or the 2D patch data and metadata for the video stream; and encode the video stream and the metadata. The metadata may include the patch area separation information and the 3D spatial information.

Preferably, the 2D patch data may be generated by separating a specific area and/or an area representing a specific object in the 2D data from the 2D data.

Preferably, the 2D patch data may include at least one of i) information on a location of the specific area and/or the specific object, ii) information on a size of the specific area and/or the specific object, iii) information on a number of the specific area and/or the specific object, iv) information on a type of the specific area and/or the specific object, or v) information on a characteristic of the specific area and/or the specific object.

Preferably, the patch area separation information may be information for distinguishing between a patch area and a non-patch area in the 2D data.

Preferably, the patch area separation information may include information on vertexes and connecting lines of a polygon defining the 2D patch data.

Preferably, the patch area separation information may be stored in a channel in a color space representing the 2D patch data.

Preferably, the 3D spatial information may include at least one of i) 3D position information of the 2D patch data, ii) frontal direction information of the 2D patch data in a 3D space, or iii) movement range information of the 2D patch data in a 3D space.

According to an embodiment of the present invention, 2D data input can be directly reproduced as 3D data.

According to an embodiment of the present invention, stored or transmitted 2D data can be input and arranged and visualized in 3D space with a 3D media tool.

According to an embodiment of the present invention, when 2D patch data means one object, each 2D data patch can be individually arranged in 3D space and a real-time 3D rendering function can be implemented.

According to an embodiment of the present invention, the same effect can be obtained in 3D data generation/compression/transmission through the preprocessing/transmission/compression process of existing 2D video.

According to an embodiment of the present invention, a method of merging compression/transmission/reproduction of multiple 2D patch data can have the same effect as merging compression/transmission/reproduction of multiple 3D object data.

According to an embodiment of the present invention, it can be utilized in immersive applications such as 2/3D games, 2/3D simulations, and 2/3D video calls.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a 2D data encoding/decoding system for 3D rendering according to one embodiment of the present invention.

FIG. 2 is a diagram illustrating a video stream and metadata generating unit according to one embodiment of the present invention.

FIG. 3 illustrates a 2D data encoding method for 3D rendering according to one embodiment of the present invention.

FIG. 4 is a block diagram of an apparatus for a 2D data encoding/decoding method for 3D rendering according to one embodiment of the present invention.

### DETAILED DESCRIPTION

Since the present disclosure can make various changes and have various embodiments, specific embodiments will be illustrated in the drawings and described in detail in the detailed description. However, this is not intended to limit the present disclosure to specific embodiments, and should be understood to include all changes, equivalents, and substitutes included in the feature and technical scope of the present disclosure. Similar reference numbers in the drawings refer to identical or similar functions across various aspects. The shapes and sizes of elements in the drawings may be exaggerated for clearer explanation. For a detailed description of the exemplary embodiments described below, refer to the accompanying drawings, which illustrate specific embodiments by way of example. These embodiments are described in sufficient detail to enable those skilled in the art to practice the embodiments. It should be understood that the various embodiments are different from one another but are not necessarily mutually exclusive. For example, specific shapes, structures and characteristics described herein with respect to one embodiment may be implemented in other embodiments without departing from the spirit and scope of the disclosure. Additionally, it should be understood that the position or arrangement of individual components within each disclosed embodiment may be changed without departing from the spirit and scope of the embodiment. Accordingly, the detailed description that follows is not to be intended in a limiting sense, and the scope of the exemplary embodiments is limited only by the appended claims, together with all equivalents to what those claims assert if properly described.

In the present disclosure, terms such as first, second, etc. may be used to describe various components, but the components should not be limited by the terms. The above terms are used only for the purpose of distinguishing one component from another. For example, a first component may be referred to as a second component, and similarly, the second component may be referred to as a first component without departing from the scope of the present disclosure. The term “and/or” includes any of a plurality of related stated items or a combination of a plurality of related stated items.

When a component of the present disclosure is referred to as being “connected” or “accessed” to another component, it may be directly connected or connected to the other component, but other components may exist in between. It must be understood that it may be possible. On the other hand, when it is mentioned that a component is “directly connected” or “directly accessed” to another component, it should be understood that there are no other components in between.

The components appearing in the embodiments of the present disclosure are shown independently to represent different characteristic functions, and do not mean that each component is comprised of separate hardware or one software component. That is, each component is listed and included as a separate component for convenience of explanation, and at least two of each component can be combined to form one component, or one component can be divided into a plurality of components to perform a function, and each of these components can be divided into a plurality of components. Integrated embodiments and separate embodiments of the constituent parts are also included in the scope of the present disclosure as long as they do not deviate from the essence of the present disclosure.

The terms used in this disclosure are only used to describe specific embodiments and are not intended to limit the disclosure. Singular expressions include plural expressions unless the context clearly dictates otherwise. In the present disclosure, terms such as “comprise” or “have” are intended to designate the presence of features, numbers, steps, operations, components, parts, or combinations thereof described in the specification, but are not intended to indicate the presence of one or more other features. It should be understood that this does not exclude in advance the possibility of the existence or addition of elements, numbers, steps, operations, components, parts, or combinations thereof. In other words, the description of “including” a specific configuration in this disclosure does not exclude configurations other than the configuration, and means that additional configurations may be included in the scope of the implementation of the disclosure or the technical feature of the disclosure.

Some of the components of the present disclosure may not be essential components that perform essential functions in the present disclosure, but may simply be optional components to improve performance. The present disclosure can be implemented by including only essential components for implementing the essence of the present disclosure, excluding components used only to improve performance, and a structure that includes only essential components excluding optional components used only to improve performance is also included in the scope of rights of this disclosure.

Hereinafter, embodiments of the present disclosure will be described in detail with reference to the drawings. In describing the embodiments of the present specification, if it is determined that a detailed description of a related known configuration or function may obscure the gist of the present specification, the detailed description will be omitted, and the same reference numerals will be used for the same components in the drawings. Redundant descriptions of the same components are omitted.

The present invention relates to a method for allocating three-dimensional spatial information corresponding to each two-dimensional data, transmitting the three-dimensional spatial information and the two-dimensional data simultaneously, and rendering the two- dimensional data on the three-dimensional space. Specifically, the present invention proposes a method for encoding and transmitting (by patch or by frame) 3D spatial information and (static/dynamic) background separation information corresponding to input 2D image data together with 2D image data, and/or a 3D rendering method of 2D image data based on 3D spatial information.

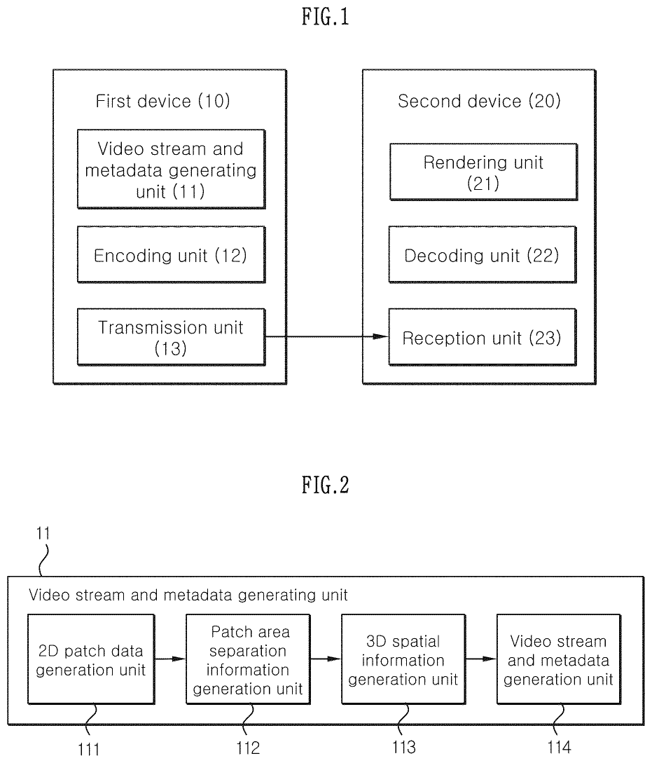

FIG. 1 illustrates a 2D data encoding/decoding system for 3D rendering according to one embodiment of the present invention.

Referring to FIG. 1, a 2D data encoding/decoding system for 3D rendering may be configured to include a first device (10) (i.e., a content provider, for example, an encoding device) and a second device (20) (i.e., a content player, for example, a decoding device).

The first device (10) refers to a device that generates 2D data for 3D rendering and provides the generated 2D data to the second device (20), and may be configured to include at least one of a video stream and metadata generating unit (11), an encoding unit (12), and a transmission unit (13).

The video stream and metadata generating unit (11) may perform a process of generating one or more 2D patch data based on a single 2D image data, a process of assigning 3D information for the 2D image data and/or the 2D patch data, a process of rearranging the 2D data and/or the 2D patch data, and a process of separating the 2D patch data area within the rearranged 2D image data by utilizing the separated structure of the 2D video standard.

The encoding unit (12) can compress the original or rearranged 2D image data and the 3D spatial information corresponding to the 2D patch data into one video stream. In addition, the encoding unit (12) can store the original or rearranged 2D image data and the 2D patch data as a video stream, and store the corresponding ‘3D spatial information’ and ‘patch area separation information’ for each video stream in the form of metadata.

The transmission unit (13) can transmit/provide the video stream and metadata (i.e., bitstream) to the second device (20) (e.g., by including them in the same transmission unit and transmitting them).

The second device (20) means a device that performs 3D rendering based on original or rearranged 2D image data using the video stream and metadata provided from the first device (10), and can be configured to include at least one of a rendering unit (21), a decoding unit (22), and a reception unit (23).

The reception unit (23) can receive a bitstream (i.e., a video stream and metadata) provided from the first device (10).

The decoding unit (22) decodes the bitstream and can obtain information necessary for rendering through it.

The rendering unit (23) can 3D render the decoded 3D data and provide/output a 3D visualized scene to a user.

In FIG. 1, for the convenience of explanation, the 2D data encoding/decoding system for 3D rendering is illustrated as being divided into the first device (10) and the second device (20), but the present invention is not limited thereto. That is, the system of FIG. 1 can be implemented as one device, and in this case, the first device (10) and the second device (20) can be configured as components within one device.

FIG. 2 is a diagram illustrating a video stream and metadata generating unit according to one embodiment of the present invention.

FIG. 2 illustrates a video stream and metadata generating unit (11) in the first device (10) exemplified in FIG. 1, and may be configured to include a 2D patch data generation unit (111), a patch area separation information generation unit (112), a 3D spatial information generation unit (113), and a video stream and metadata generation unit (114).

The 2D patch data generation unit (111) may obtain one or more 2D patch data information from 2D data (e.g., 2D image data, 2D video data, etc.). Here, the 2D data may include a general image, a general video, a multi-view image, a multi-view video, a multi-view depth image, a multi-view depth video, etc.

Specifically, the 2D patch data generation unit (111) can derive data on (main) areas and/or objects included in the 2D data into 2D patch data information.

Here, the 2D patch data information can include at least one of information on the location of (main) area(s) and/or object(s), information on the size of (main) area(s) and/or object(s), information on the number of (main) area(s) and/or object(s), information on the type of (main) area(s) and/or object(s), or information on the characteristics of (main) area(s) and/or object(s). Here, the (main) area can be configured based on area(s) including an object(s).

The information on the location and size may indicate the location and/or size of area(s) occupied by the (main) area(s) and/or the object(s) in the 2D data. The information on the type of the (main) area(s) and/or object(s) may include at least one of whether it is a foreground/background and whether the state of the object is dynamic/static. For example, the 2D patch data generation unit (111) can extract one or more (main) areas and objects included in the 2D image data by applying techniques such as object detection, object segmentation, and matting to the 2D image data. In addition, in the case of dynamic 2D image data, the 2D patch data generation unit (111) can extract tracking information of (main) area(s) and object(s) that change over time together. Here, the object tracking information can include movement information of the object(s) over time. For example, by applying an object detection technique or an object segmentation technique, a patch including an object can be extracted from a 2D image. Here, a shape of a patch can be a square shape or a polygonal shape. In addition, a patch can be separated into valid area(s) and invalid area(s). Here, the valid area indicates area(s) including pixels occupied by an object, and the invalid area indicates area(s) including pixels not occupied by an object.

Here, each extracted (main) region or (main) object can be designated as one two-dimensional patch data. That is, the patch data can further include not only texture/geometry data for the object, but also region and movement information containing the object. In addition, a different identifier can be assigned to each (main) region or (main) object. Information on the (main) region and/or the object tracking information can be encoded/decoded corresponding to the identifier of each (main) region or (main) object.

In order to generate 2D patch data, the 2D patch data generation unit (111) can separate one or more (main) areas and/or areas representing objects from the 2D data. Here, a shape of the separated area can be a rectangle or a polygon. 2D patch data can be generated from the separated areas. Specifically, data in a form of a rectangular bounding box or a manifold/non-manifold polygon including a (main) area and/or an object on 2D data, can be configured as 2D patch data. That is, one (main) area and/or one object can be defined as one 2D patch data. As a result, the 2D patch data can be data in a rectangular shape or a polygonal shape.

The patch area separation information generation unit (112) can generate ‘patch area separation information’ for each 2D patch data that separates 2D patch data in 2D data.

Here, ‘patch area separation information’ can mean information for separating ‘patch area’ and ‘non-patch area’ in 2D data.

Example 1) The patch area separation information may include information on vertices and connecting lines of a square or manifold/non-manifold polygon defining 2D patch data. For example, the patch area separation information may include information indicating the position of at least one vertex for a polygon of a predetermined shape, the distance between two vertices constituting the polygon, etc. In addition, the patch area separation information may indicate the position and/or size of 2D patch data extracted from 2D image data, or may be for separating valid and non-valid areas within the 2D patch data.

Example 2) The patch area separation information can be stored in one channel within a color space expressing the 2D patch data. For example, if the original 2D patch data is expressed as an RGB (red green blue) image, the color space can be converted from RGB to RGBA (red green blue alpha), and the patch area separation information can be recorded/stored in the A (Alpha) channel value. For example, a value of a pixel corresponding to the patch area in the A image may be set to a first pixel value, and a value of a pixel corresponding to the non-patch area (i.e., a value of a pixel not included in the patch) may be set to a second pixel value. Here, the first pixel value and the second pixel value may be values that are predefined/preconfigured in the encoder/decoder. For example, the first pixel value may be ‘255’ and the second pixel value may be ‘0’. Alternatively, depending on a bit depth, the maximum value or median value that can be expressed by the bit depth may be set as the first pixel value.

Example 3) As the patch area separation information, a mask or occupancy map for each 2D patch data can be generated.

Here, the mask may be for distinguishing valid and invalid areas within the patch. For example, the pixel value corresponding to the valid area within the mask image may be set to a first value, and the pixel value corresponding to the invalid area may be set to a second value. Here, one of the first value and the second value may be 1, and the other may be 0. In addition, the occupancy map is an image of the same size as the 2D image, and the pixel value corresponding to the location occupied by the patch in the occupancy map may be set to a first value, and the pixel value corresponding to the location not occupied by the patch may be set to a second value. Here, the first value and the second value may be values predefined/preconfigured in the decoder/decoder. For example, one of the first value and the second value may be 1 and the other may be 0. Alternatively, the first value in the occupancy map may be set to an index value assigned to the patch. Meanwhile, the occupancy map may be scaled to a smaller size than the 2D image and decoded. In addition, at least one 2D patch data extracted from the same 2D data may be rearranged and merged into one frame. Alternatively, each 2D patch data may be configured as an individual frame. Alternatively, a plurality of 2D patch data may be classified into a plurality of groups, and an individual frame may be generated based on each of the groups.

The 3D spatial information generation unit (113) can assign 3D spatial information as well as 2D spatial information to 2D data and/or 2D patch data.

The 3D spatial information that can be assigned to the 2D patch data may include at least one of 3D position information (x, y, z) of the 2D patch data in the 3D space, frontal direction information (0x, 0y, 0z) of the 2D patch data in the 3D space, or movement range information (x_limit[xmin, xmax], y_limit[ymin, ymax], z_limit[zmin, zmax]) of the 2D patch data in the 3D space.

The 3D spatial information can be determined based on the projection matching information/relative position of the main area and/or object on the 2D data. For example, an area corresponding to a floor on the 2D data can be divided according to a distance, and the 3D spatial information for the object can be generated based on where the position of the object on the floor is located among the divided regions. That is, after matching the area corresponding to the floor of the 2D data to the 3D floor area, the 3D spatial information for each 2D patch data can be generated based on the matching information between the input 2D area and the 3D area. Meanwhile, the ‘projection matching information between 2D data and 3D space’ that matches the floor of the 2D data to the 3D floor area can also be generated by being manually input from an external source (e.g., a user).

In addition, based on the above ‘projection matching information between 2D data and 3D space’, position information and/or direction information on which 2D patch data is arranged in 3D space can be acquired. Specifically, based on the above ‘projection matching information between 2D data and 3D space’, the position and/or direction of 2D patch data for each frame in 3D space can be acquired throughout an entire sequence of static/dynamic 2D data. In addition, based on the ‘projection matching information between 2D data and 3D space’, the movement range of individual 2D patch data (e.g., object) in the 3D space and the entire movement range of the entire 2D patch data in the 3D space for the sequence unit can be acquired. Depending on the movement range and movement direction of the object, direction information of the object for a specific frame can be generated.

The video stream and metadata generation unit (114) can group one or more 2D image data and/or 2D patch data by frame or patch and rearrange and merge them into one 2D image data. Here, a plurality of 2D patch data can be packed into a 2D image. A 2D image into which a plurality of 2D patch data are packed can be called an atlas.

Meanwhile, the video stream and metadata generation unit (114) can classify one or more 2D patch data included in the same frame into one of a plurality of groups, and rearrange and merge each of the 2D patch data groups into one 2D image data. Here, 2D patch data that are spatially adjacent can be classified into one group. Accordingly, 2D patches in the 2D patch data group are positioned spatially adjacent, and as a result, 2D image data generated from each of the 2D patch data groups can be spatially separated from each other. Here, by arranging the 2D image data according to depth, an image in the form of MPI can also be generated.

That is, a depth-based layered immersive video with MPI technique applied can be in the form of one 2D patch data group placed on one 2D image data (i.e., one 2D plane).

Meanwhile, in grouping 2D patch data, patches extracted from the same area or the same object can be classified into the same group. In addition, not only the current frame, but also 2D patch data of frames adjacent to the current frame in display order or encoding order can be classified into the same group. Alternatively, grouping can be performed on 2D patch data extracted in units of a predetermined period, for example, GOP (group of picture).

In addition, the video stream and metadata generation unit (114) can use the segmentation concept of the existing 2D image data codec to distinguish each 2D patch data area within the rearranged or merged 2D image data. For example, segmentation concepts such as VVC's tile, slice, and subpicture can be applied to the 2D image data. Through the above segmentation technique, independent/partial sub/decoding or parallel processing support for each of the segmented areas can be possible. For example, each 2D area data can be separated into a plurality of segmentation units such as tiles, slices, and subpictures, and each of the separated areas can support independent encoding/decoding and parallel processing of multiple patches.

Referring again to FIG. 1, the encoding unit (12) in the first device (10) can compress original or rearranged 2D image data and/or 2D patch data. That is, the encoding unit (12) can perform encoding for each 2D image data and/or 2D patch data. Here, ‘3D spatial information’ and ‘patch area separation information’ for the 2D patch data can also be encoded together.

As described above, the ‘3D spatial information’ may include 3D position information (x, y, z) arranged in the 3D space for each 2D data or 2D patch data, frontal direction information (0x, 0y, 0z) of the 2D data in the 3D space, movement range information of the 2D data in the 3D space (x_limit[xmin, xmax], y_limit[ymin, ymax], z_limit[zmin, zmax]), etc.

In addition, as described above, the ‘patch area separation information (or, foreground/background separation information for each patch)’ may include at least one of i) information for separating area(s) occupied by 2D patch data in 2D image data, or ii) segmentation information for distinguishing patch area(s) (foreground) and non-patch area(s) (background) for each 2D patch data when one or more 2D patch data exist in 2D image data. Here, the segmentation information may be expressed as identifier (ID) information of a 2D mask, vertex information of a segmentation boundary, etc.

In addition, the transmission unit (13) in the first device (10) can transmit an encoded bitstream for each 2D image data and/or 2D patch data to the second device (20). In addition, the transmission unit (13) in the first device (10) can also encode and transmit ‘3D spatial information’ and ‘patch area separation information’ for the 2D patch data.

In addition, for example, the transmission unit (13) can transmit segmentation information and depth information for each layer of the immersive video in the form of MPI together with the VVC encoded stream in the form of a supplemental enhancement information (SEI) message.

Specifically, the transmission unit (13) in the first device (10) may transmit the original or rearranged 2D data and/or 2D patch data as a video stream, and may include the corresponding ‘3D spatial information’ and ‘patch area separation information’ for each video stream in the form of metadata in the same transmission unit. In addition, the transmission unit (13) in the first device (10) may transmit the 2D image data and 2D patch data as a video stream, and may transmit the corresponding ‘3D spatial information’ and ‘patch area separation information’ for each video stream in the form of metadata. Meanwhile, the video stream and metadata may be included in the same transmission unit and transmitted together.

Alternatively, the transmission unit (13) in the first device (10) may transmit ‘3D spatial information’ and ‘patch area separation information’ for each 2D image data and/or each 2D patch data as metadata of the 2D image data.

When a 2D image data stream is generated, metadata (timed metadata) in which ‘3D spatial information’ and ‘patch area separation information’ for each 2D image data and/or each 2D patch data are stored can be generated together. In this case, the metadata can be included in the 2D image data stream and transmitted continuously/non-continuously, and the second device (20) can simultaneously receive metadata from the 2D data stream. For example, a 2D player playing a 2D live stream can simultaneously receive metadata while receiving 2D data, and display the value of the metadata and the time of reception.

Alternatively, the transmission unit (13) in the first device (10) may include ‘3D spatial information’ and ‘patch area separation information’ for each 2D image data and 2D patch data in a transmission data unit and transmit them together with the 2D image data stream.

For example, based on the media file format (ISO BMFF), 2D data streams and metadata can be included in the same multimedia unit, and the multimedia unit can be transmitted in real time/non-real time using the MPEG-DASH streaming protocol. In particular, for real-time data transmission, a DASH segment can include a certain amount of 2D data and metadata corresponding to the 2D data ('3D spatial information' and ‘patch segmentation information’) and be transmitted in real time to a second device (20) (e.g., a client, a terminal).

In addition, the decoding unit (22) in the second device (20) can restore 2D data and information such as ‘3D spatial information’ and ‘patch area separation information’ corresponding to each 2D data from the received 2D data stream. That is, the decoding unit (22) in the second device (20) can decode the video stream and metadata from the received data stream.

In addition, the decoding unit (22) in the second device (20) can plot an object included in the 2D patch data on a 3D space based on the 3D spatial information and patch separation information of the decoded 2D patch data. Specifically, when the 2D patch data and the ‘3D spatial information’ and ‘patch area separation information’ corresponding to the 2D patch data are restored together, the decoding unit (22) can convert each 2D patch data into 3D data.

When restoring 2D date, pixels in the area corresponding to the 2D patch data can be converted and expanded into 3D coordinates, and the converted 3D data can be saved in a 3D data file format such as OBJ, PLY, etc. For example, when multiple objects in a 2D image are defined as 2D patch data for each object, each 2D patch data (frame in YUV (YIQ/YCbCr/YPbPr), RGB format) can be converted into a 3D file (OBJ, PLY, etc.). As a result, multiple objects in a 2D image can be regenerated as a 3D OBJ file. Individual 2D patch data can be converted into one 3D data independently, or a group of 2D data grouped by 2D patch data or frame can be converted into one 3D data.

In addition, the rendering unit (21) in the second device (20) can receive the converted 3D data and place and render it in 3D space using an existing 3D media processing tool. Accordingly, the user can view the 3D visualized scene. Here, the rendering unit (21) can place one or more 2D data patches in various distributions in 3D space according to 3D space information for each 2D patch data. Accordingly, the user can view the scene in 3D.

For example, when 2D data in which multiple objects exist is separated into 2D patch data and transmitted, the 2D patch data for each object is converted into 3D data, and multiple objects can be placed and rendered in 3D space.

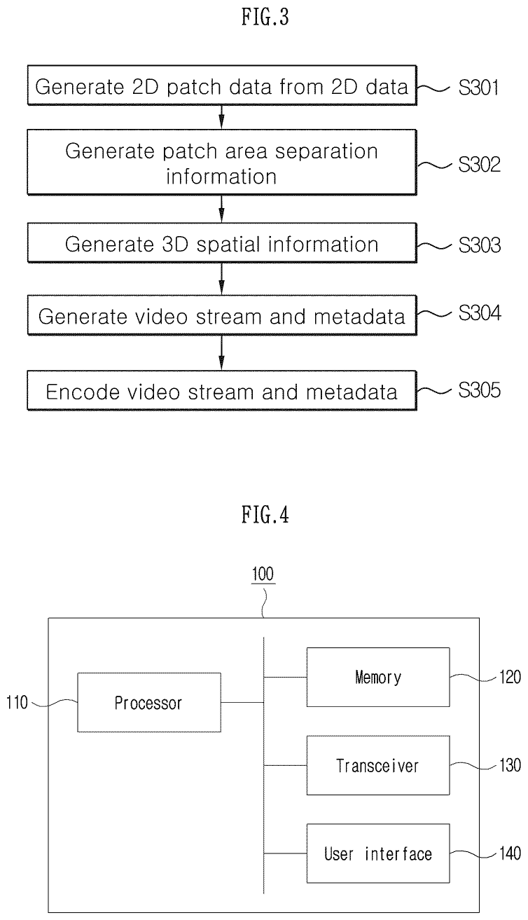

FIG. 3 illustrates a 2D data encoding method for 3D rendering according to one embodiment of the present invention.

Referring to FIG. 3, the first device (10) generates 2D patch data from 2D data (S301).

Here, the 2D patch data can be generated by separating specific area(s) and/or area(s) representing specific object(s) within the 2D data from the 2D data.

In addition, the 2D patch data may include at least one of i) information on the location of specific area(s) and/or specific object(s), ii) information on the size of specific area(s) and/or specific object(s), iii) information on the number of specific area(s) and/or specific object(s), iv) information on the type of specific area(s) and/or specific object(s), or v) information on the characteristics of specific area(s) and/or specific object(s).

The first device (10) generates patch area separation information for distinguishing 2D patch data within 2D data (S302).

Here, the patch area separation information may mean information for distinguishing patch area(s) and non-patch area(s) within 2D data.

For example, the patch area separation information may include information on vertexes and connecting lines of polygon(s) defining the 2D patch data. As another example, the patch area separation information may be stored in any one channel within a color space representing the 2D patch data.

The first device (10) generates 3D spatial information for the 2D data and/or the 2D patch data (S303).

Here, the 3D spatial information may include at least one of i) 3D position information of the 2D patch data, ii) frontal direction information of the 2D patch data in the 3D space, or iii) movement range information of the 2D patch data in the 3D space.

The first device (10) generates a video stream including 2D data and/or 2D patch data and metadata for the video stream (S304).

Here, metadata may include patch area separation information and 3D spatial information.

The first device (10) encodes the video stream and metadata (S305).

The first device (10) can transmit the encoded video stream and metadata (i.e., bitstream) to the second device (20). The second device (20) can decode the received bitstream and perform 3D rendering based on the video stream and metadata obtained through it.

FIG. 4 is a block diagram of an apparatus for a 2D data encoding/decoding method for 3D rendering according to one embodiment of the present invention.

The apparatus (100) for 2D data encoding/decoding method for 3D rendering may include one or more processors (110), one or more memories (120), one or more transceivers (130), one or more user interfaces (140), etc. The memory (120) may be included in the processor (110) or may be configured separately. The memory (120) may store instructions that cause the apparatus (100) to perform operations when executed by the processor (110).

The transceiver (130) may transmit and/or receive signals, data, etc. that the apparatus (100) exchanges with other entities. The user interface (140) may receive a user's input for the apparatus (100) or provide the output of the apparatus (100) to the user. Among the components of the apparatus (100), components other than the processor (110) and the memory (120) may not be included in some cases, and other components not shown in FIG. 4 may be included in the apparatus (100).

The processor (110) may be configured to cause the apparatus (100) to perform the methods according to various examples of the present disclosure. Although not illustrated in FIG. 4, the processor (110) may be configured as a set of modules that perform each method/function proposed in the present disclosure. The modules may be configured in the form of hardware and/or software.

When the apparatus (100) corresponds to the first device (10) of FIG. 1, the operation is described as follows.

The processor (110) generates 2D patch data from 2D data.

Here, the 2D patch data can be generated by separating area(s) representing specific area(s) and/or specific object(s) in the 2D data from the 2D data.

In addition, the 2D patch data can include at least one of i) information on the location of the specific area(s) and/or the specific object(s), ii) information on the size of the specific area(s) and/or the specific object(s), iii) information on the number of the specific area(s) and/or the specific object(s), iv) information on the type of the specific area(s) and/or the specific object(s), or v) information on the characteristics of the specific area(s) and/or the specific object(s).

The processor (110) generates patch area separation information for separating 2D patch data in the 2D data.

Here, the patch area separation information can mean information for separating patch area(s) and non-patch area(s) in the 2D data.

For example, the patch area separation information may include information on vertexes and connecting lines of a polygon defining the 2D patch data. As another example, the patch area separation information may be stored in any one channel within a color space representing the 2D patch data.

The processor (110) generates 3D spatial information for the 2D data and/or the 2D patch data.

Here, the 3D spatial information may include at least one of i) 3D position information of the 2D patch data, ii) frontal direction information of the 2D patch data in the 3D space, or iii) movement range information of the 2D patch data in the 3D space.

The processor (110) generates a video stream containing 2D data and/or 2D patch data and metadata for the video stream.

Here, the metadata may include patch area separation information and 3D spatial information.

The processor (110) encodes the video stream and metadata.

The transceiver (130) can transmit the encoded video stream and metadata (i.e., bitstream) to another apparatus.

When the apparatus (100) corresponds to the second apparatus (20) of FIG. 1, the operation is described as follows.

The transceiver (130) can receive an encoded video stream and metadata (i.e., a bitstream).

The processor (110) can decode the received/input bitstream and perform 3D rendering based on the video stream and metadata obtained through the decoding.

Components described in exemplary embodiments of the present disclosure may be implemented by hardware elements. For example, the hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in exemplary embodiments may be implemented in a combination of hardware and software.

The method according to an embodiment of the present disclosure may be implemented as a program that can be executed by a computer, and the computer program may be recorded in various recording media such as magnetic storage media, optical read media, and digital storage media.

The various technologies described in this disclosure may be implemented as digital electronic circuits or computer hardware, firmware, software, or a combination thereof. The above technologies may be implemented as a computer program product, that is, a computer program tangibly embodied in an information medium (e.g., a machine-readable storage device (e.g., a computer-readable medium) or a data processing device) or a computer program implemented as signals processed by or propagated by a data processing device to cause the operation of the data processing device (e.g., programmable processor, computer, or multiple computers).

Computer program(s) may be written in any form of programming language, including compiled or interpreted languages and may be distributed as a stand-alone program or in any form, including modules, components, subroutines, or other units suitable for use in a computing environment. A computer program may be executed by a single computer or by multiple computers distributed at one site or multiple sites and interconnected by a communications network.

Examples of processors suitable for executing computer programs include general-

purpose and special-purpose microprocessors, and one or more processors in digital computers. Typically, a processor receives instructions and data from read-only memory, random access memory, or both. Components of a computer may include at least one processor for executing instructions and one or more memory devices for storing instructions and data. Additionally, the computer may include one or more mass storage devices for data storage, such as magnetic, magneto-optical disks, or optical disks, or may be connected to the mass storage devices to receive and/or transmit data. Examples of information media suitable for implementing computer program instructions and data include optical media such as semiconductor memory devices (e.g., magnetic media such as hard disks, floppy disks, and magnetic tapes), compact disk read-only memory (CD-ROM), digital video disk (DVD), etc., magneto-optical media such as floptical disks, and read only memory (ROM), random access memory (RAM), flash memory, erasable programmable ROM (EPROM), electrically erasable programmable ROM (EEPROM), and other known computer-readable media. Processors and memories can be supplemented or integrated by special-purpose logic circuits.

A processor may run an operating system (OS) and one or more software applications that run on the OS. The processor device may also access, store, manipulate, process and generate data in response to software execution. For simplicity, the processor device is described in the singular, but those skilled in the art will understand that the processor device may include a plurality of processing elements and/or various types of processing elements. For example, a processor device may include a plurality of processors or a processor and a controller. Additionally, different processing structures, such as parallel processors, may be configured. Additionally, computer-readable media refers to all media that a computer can access, and may include both computer storage media and transmission media.

Although this disclosure includes detailed descriptions of various detailed implementation examples, the details should not be construed as limiting the invention or scope of the claims proposed in this disclosure, but rather illustrating features of specific exemplary embodiments.

Features individually described in exemplary embodiments in this disclosure may be implemented by a single exemplary embodiment. Conversely, various features described in this disclosure with respect to a single exemplary embodiment may be implemented by a combination or appropriate sub-combination of a plurality of exemplary embodiments. Furthermore, in the present disclosure, the features may operate by a specific combination, and the combination may initially be described as claimed, however, in some cases, one or more features may be excluded from the claimed combination, or claimed combinations may be modified in the form of sub-combinations or modifications of sub-combinations.

Similarly, even if operations are depicted in a specific order in the drawings, it should not be understood that execution of the operations in a specific order or sequence is necessary, or that performance of all operations is required to obtain a desired result. In certain cases, multitasking and parallel processing can be useful. Additionally, it should not be understood that the various device components in all exemplary embodiments are necessarily separate, and the above-described program components and devices may be packaged in a single software product or multiple software products.

The exemplary embodiments disclosed herein are illustrative only and are not intended to limit the scope of the disclosure. Those skilled in the art will recognize that various modifications may be made to the exemplary embodiments without departing from the scope of the claims and their equivalents.

Accordingly, this disclosure is intended to include all other substitutions, modifications and changes that fall within the scope of the following claims.

What is claimed is:

1. A method for encoding two-dimensional (2D) video data for three-dimensional (3D) rendering, the method comprising:
generating one or more 2D patch data from 2D data;
generating patch area separation information for distinguishing the 2D patch data in the 2D data;
generating 3D spatial information for the 2D data and/or the 2D patch data;
generating a video stream including the 2D data and/or the 2D patch data and metadata for the video stream, wherein the metadata includes the patch area separation information and the 3D spatial information; and
encoding the video stream and the metadata.

2. The method of claim 1, wherein the 2D patch data is generated by separating a specific area and/or an area representing a specific object in the 2D data from the 2D data.

3. The method of claim 1, wherein the 2D patch data includes at least one of i) information on a location of the specific area and/or the specific object, ii) information on a size of the specific area and/or the specific object, iii) information on a number of the specific area and/or the specific object, iv) information on a type of the specific area and/or the specific object, or v) information on a characteristic of the specific area and/or the specific object.

4. The method of claim 1, wherein the patch area separation information is information for distinguishing between a patch area and a non-patch area in the 2D data.

5. The method of claim 4, wherein the patch area separation information includes information on vertexes and connecting lines of a polygon defining the 2D patch data.

6. The method of claim 4, wherein the patch area separation information is stored in a channel in a color space representing the 2D patch data.

7. The method of claim 1, wherein the 3D spatial information includes at least one of i) 3D position information of the 2D patch data, ii) frontal direction information of the 2D patch data in a 3D space, or iii) movement range information of the 2D patch data in a 3D space.

8. An apparatus for encoding two-dimensional (2D) video data for three-dimensional (3D) rendering, the apparatus comprising:
a 2D patch data generation unit for generating one or more 2D patch data from 2D data;
a patch area separation information generation unit for generating patch area separation information for distinguishing the 2D patch data in the 2D data;
a 3D spatial information generation unit for generating 3D spatial information for the 2D data and/or the 2D patch data;
a video stream and metadata generation unit for generating a video stream including the 2D data and/or the 2D patch data and metadata for the video stream; and
encoding the video stream and the metadata,
wherein the metadata includes the patch area separation information and the 3D spatial information.

9. The apparatus of claim 8, wherein the 2D patch data is generated by separating a specific area and/or an area representing a specific object in the 2D data from the 2D data.

10. The apparatus of claim 8, wherein the 2D patch data includes at least one of i) information on a location of the specific area and/or the specific object, ii) information on a size of the specific area and/or the specific object, iii) information on a number of the specific area and/or the specific object, iv) information on a type of the specific area and/or the specific object, or v) information on a characteristic of the specific area and/or the specific object.

11. The apparatus of claim 8, wherein the patch area separation information is information for distinguishing between a patch area and a non-patch area in the 2D data.

12. The apparatus of claim 11, wherein the patch area separation information includes information on vertexes and connecting lines of a polygon defining the 2D patch data.

13. The apparatus of claim 11, wherein the patch area separation information is stored in a channel in a color space representing the 2D patch data.

14. The apparatus of claim 8, wherein the 3D spatial information includes at least one of i) 3D position information of the 2D patch data, ii) frontal direction information of the 2D patch data in a 3D space, or iii) movement range information of the 2D patch data in a 3D space.

15. At least one non-transitory computer-readable medium storing at least one instruction, wherein the at least one instruction executable by at least one processor controls an apparatus for encoding two-dimensional (2D) video data for three-dimensional (3D) rendering to:
generate one or more 2D patch data from 2D data;
generate patch area separation information for distinguishing the 2D patch data in the 2D data;
generate 3D spatial information for the 2D data and/or the 2D patch data;
generate a video stream including the 2D data and/or the 2D patch data and metadata for the video stream; and
encode the video stream and the metadata,
wherein the metadata includes the patch area separation information and the 3D spatial information.
